(19) United States
(12) Patent Application Publication
(10) Pub. No.: US 2016/0019153 A1
(43) Pub. Date: Jan. 21, 2016

(54) PRE-LOADING CACHE LINES

(71) Applicant: ELLIPTIC TECHNOLOGIES INC., Kanata (CA)

(72) Inventors: Michael James Lewis, Ottawa (CA); Neil Farquhar Hamilton, Kanata (CA)

(21) Appl. No.: 14/335,286

(22) Filed: Jul. 18, 2014

(51) Int. Cl. G06F 12/08

(52) U.S. Cl. CPC G06F 12/0862; G06F 2212/1021; G06F 2212/602

(57) ABSTRACT

A system for caching is configured for a pending lock state of a cache line, pre-loading the cache line into cache memory, and locking the cache line to prevent eviction of the cache line from the cache memory. The cache line is associated with instructions or data, and the pre-loading of the cache line may include loading the cache line into the cache memory before an algorithm relying on the instructions or data needs them. The pre-loading of a cache line associated with instructions may be done without execution of the instructions. The pending lock state of the cache line may be achieved by configuring the cache system to know that, when a cache line associated with an address is loaded into the cache memory, it should lock the cache line. The locking of the cache line may be done by promoting the pending lock state to a locked state.

### FIELD OF THE INVENTION

The present disclosure relates to the field of cache systems for pre-loading cache lines to reduce latency during time critical periods.

### BACKGROUND

Cache systems, for example, load cache lines in cache memory when an algorithm runs and the instructions therein are executed. When such cache lines are loaded into the cache memory, the time required to obtain a byte or word associated with the address in that particular cache line is much faster than the time that would be required to obtain the byte or word associated with the address from the main system memory.

During algorithm runs, when the cache line associated with the instructions of the algorithm is not in the cache memory then this leads to a cache line miss. When cache line misses happen, this would require loading of the cache line into cache memory first and then providing or obtaining the necessary information from the cache line in the cache memory for the algorithm to continue running This leads to latency issues during execution of certain time critical algorithms as will be apparent to those of ordinary skill in the art.

Existing solutions do not provide a mitigation to reduce such latency issues for time critical algorithms. Therefore, there is a need for loading cache lines in such a way that long latency times, for example due to cache misses, are reduced for time critical algorithms.

This background information is provided to reveal information believed by the applicant to be of possible relevance to the present disclosure. No admission is necessarily intended, nor should be construed, that any of the preceding information constitutes prior art against the present disclosure.

### BRIEF SUMMARY

An object of the present disclosure is to provide a method for pre-loading cache lines.

In accordance with an aspect of the present disclosure, there is provided a method for caching comprising configuring a cache system for a pending lock state of a cache line, pre-loading the cache line into cache memory, and locking the cache line to prevent eviction of the cache line from the cache memory. In one embodiment, the cache line is associated with instructions or data, and the pre-loading of the cache line includes loading the cache line into the cache memory before an algorithm relying on the instructions or data needs them. The pre-loading of a cache line associated with instructions may be done without execution of the instructions.

In one implementation, the pending lock state of the cache line is achieved by configuring the cache system to know that, when a cache line associated with an address is loaded into the cache memory, it should lock the cache line. The address may be associated with instructions or data. The locking of the cache line may be done by promoting the pending lock state to a locked state. The cache line may be unlocked to allow for eviction of the cache line from cache memory.

In accordance with another aspect of the present disclosure, there is provided a non-transitory computer-readable storage medium storing instructions that when executed by a computer cause the computer to perform a caching method comprising the steps of configuring a cache system for a pending lock state of a cache line, pre-loading the cache line into cache memory, and locking the cache line to prevent eviction of the cache line from the cache memory.

In accordance with another aspect of the present disclosure, there is provided a cache system comprising a cache controller, a processor, and memory that are all operatively coupled to each other and configured to establish a pending lock state of a cache line, pre-load the cache line into cache memory, and lock the cache line to prevent eviction of the cache line from the cache memory.

The foregoing and additional aspects and embodiments of the present disclosure will be apparent to those of ordinary skill in the art in view of the detailed description of various embodiments and/or aspects, which is made with reference to the drawings.

### BRIEF DESCRIPTION OF THE DRAWINGS

The foregoing and other advantages of the disclosure will become apparent upon reading the following detailed description and upon reference to the drawings.

FIG. 1 is a block diagram of a cache memory system.

FIG. 2 is a flow chart of a procedure for pre-loading a cache line.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Unless defined otherwise, all technical and scientific terms used herein have the same meaning as commonly understood by one of ordinary skill in the art to which this disclosure belongs.

The present disclosure provides a cache system configured to set a pending lock state for a cache line, associated with instructions or data of an algorithm, pre-load the cache line, and lock the cache line in cache memory to prevent eviction of the cache line from cache memory. The cache line may be held or locked in cache memory without eviction until the locked state is released to an unlocked state.

### Cache System

Generally, in order for cache line(s) pertaining to, for example instructions of an algorithm, to exist in the cache memory, the instructions need to have been executed for cache lines to be created and subsequently be available in the cache memory. When cache lines do not exist in the cache memory, this leads to a cache line miss when the algorithm runs by reading its instructions. As such, it takes a longer time for a cache line associated with those instructions to first be created, known as cache line load, using the information in the main system memory, and then continue, by further supplying that information from the cache memory for the algorithm to finish running In certain embodiments, information may refer to the address of a word or byte associated with the instructions.

By doing so, when the same instructions are to run the next time around, the information can be supplied directly from the cache memory as long as the cache line is not evicted from the cache memory, thus reducing latency issues for subsequent reads of the same instructions. A cache system may be configured to perform these actions.

Operation of a cache system as described above, may be acceptable for algorithms that are non-time critical. The delays, however, due to cache line miss and resultant cache line load can cause significant failures in algorithms that are time critical. In slow memory sub-systems, this may lead to processor delays leading to long latency times. In software pertaining to time critical requirements, this may cause failure in achieving time-related goals.

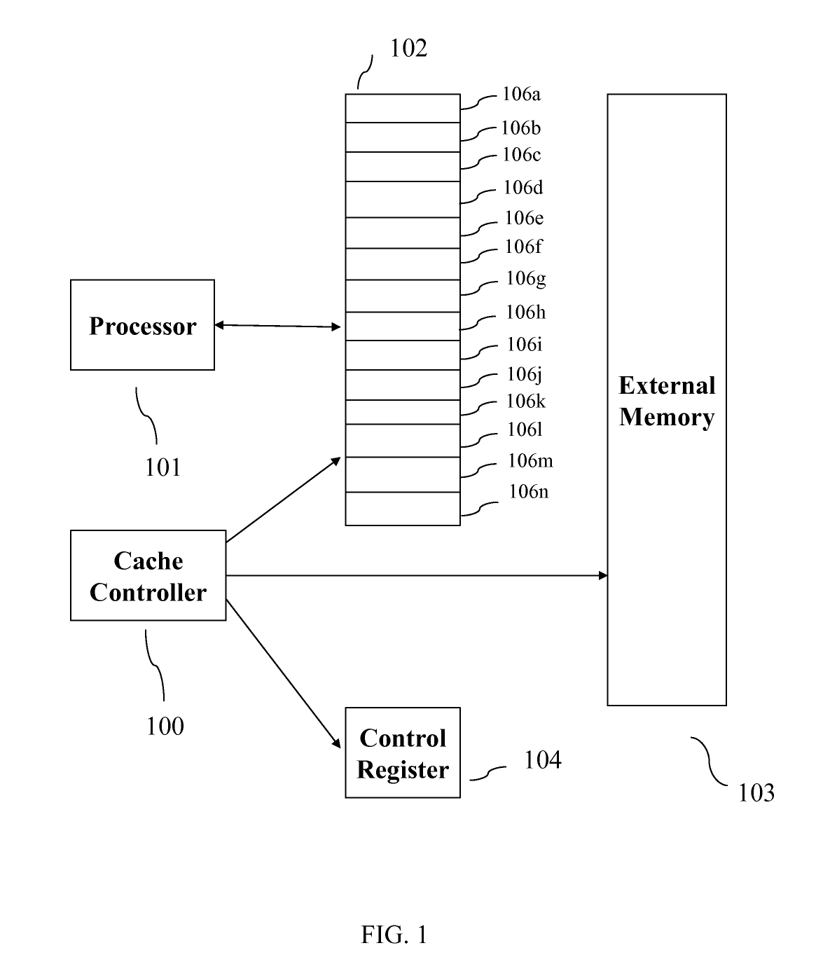

FIG. 1 illustrates a cache system that includes a cache controller 100, a processor 101, a cache memory 102, a main system memory 103, a control register 104. The system may also include a decoder and other hardware components as would be apparent to one of ordinary skill in the art. In certain embodiments, the decoder may be preceded by a cache system, which may be an instruction cache system or a data cache system. The cache system may also be used for both time-critical and non-time critical algorithms.

### Pending Lock State and Pre-Loading

In operation, the system of FIG. 1 pre-loads a cache line into the cache memory 102 using pending lock of a cache line. In certain embodiments, the method is performed during non-critical time periods. The cache system may be configured for a pending lock state of a cache line, which may then be pre-loaded into the cache memory 102 and subsequently locked to prevent eviction from the cache memory.

In some embodiments, an instruction cache system is configured to obtain information pertaining to instructions of an algorithm from the main system memory, using data load instructions as opposed to data fetches, and load the cache line associated with the instructions into the cache memory. This may be regarded as pre-loading. Pre-loading a cache line may thus take place without execution of the instructions. In certain embodiments, the algorithm is a time critical algorithm.

The cache system may be configured to know that when this particular cache line is loaded into the cache, it should be locked. This may be regarded as a pending lock state. In certain embodiments. a pending-lock bit may be set and associated with that particular cache line. As such, when the cache line is loaded into the cache memory, it is locked to prevent its eviction from the cache memory. By doing so, when the actual time-critical algorithm runs, the cache line associated with the instructions of the algorithm is already available within the cache memory, and no substantial delays are experienced during critical time periods. The cache system can be configured to pre-load a plurality of cache lines simultaneously.

In some embodiments, the cache line holds all the relevant information, such as the address of a word or byte associated with instructions or data, tags, index, etc. The information may be anything related to instructions or data necessary in creation or loading of a cache line. The information necessary for cache line creation or loading may encompass all existing methods or any future methods that can be readily devised by one of ordinary skill in the art. It is to be understood that the methods and systems disclosed herein are applicable to data cache, instruction cache, a translation look-aside buffer used to speed up virtual-to-physical address translation for both executable instructions and data, or any cache system as would be readily apparent to one of ordinary skill in the art.

In certain embodiments, the cache line may stay in its locked state until it is released to an unlocked state. The timing of its release may be dependent substantially on the actual algorithm usage. The unlocked state may be achieved by setting an unlock bit in a control register.

The time critical algorithm may be an Interrupt Service Routine (ISR). In some embodiments, the time-critical algorithm may relate to any time-sensitive algorithm that cannot afford to go through substantial delays. By pre-loading instruction cache lines, time-critical algorithms may not experience cache miss latencies, thus allowing time-critical algorithms to complete within their allocated time frame.

In some embodiments, by setting the pending lock state on a section of memory and executing a data memory load on one or more bytes/words from within the targeted external memory line, the cache system can be forced to load the cache line and promote the pending-lock state to a locked state without executing the instructions. Again, this loading may be regarded as pre-loading the cache line. When this pre-load is done at non-critical time periods, the processor does not suffer the performance penalty of cache line miss during a critical time period. In certain embodiments, the section of memory is that of the main system memory, although the section of memory may be regarded as any section of memory within any component wherein data may reside.

In some embodiments, the cache controller in a cache system is configured to use or execute the concept of a pending-lock of a cache line. In other embodiments, the processor in a cache system may be configured to use or execute the concept of a pending-lock of a cache line.

In some embodiments, the cache system may be configured in such a manner that the processor in the cache system pre-loads the cache line into cache memory without execution of the instructions. In other embodiments, the cache system may be configured in such a manner that the cache controller in the cache system is directed to pre-load the cache line into cache memory without execution of the instructions. In certain embodiments, any hardware or software component may be configured to perform the various aspects disclosed herein. It is to be understood that the concepts of pending lock state of a cache line and pre-loading a cache line may be executed in conjunction with each other or separately as desired by the requirements of the actual task wanting to use these concepts.

### Implementation Example

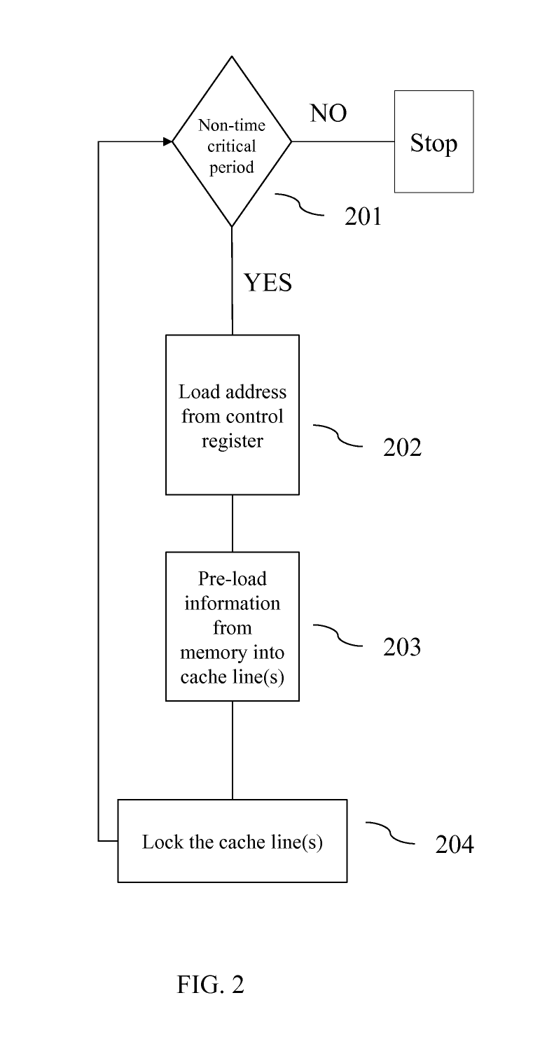

Referring to the flow chart in FIG. 2, during non-critical time periods identified in step 201, a cache system is used to pre-load a cache line associated with instructions or data of an algorithm. Pre-loading the cache line may be regarded as forcing the cache line, associated with instructions or data, to be loaded into the cache memory before the algorithm relying on the instructions or data needs them. In order to do so, the cache system may be configured to write to a control register, in step 202, the address of a byte or word relating or associated to the instructions or data within a targeted memory line.

In the case of instructions, this loading may be performed without execution of the instructions. The cache system may be configured to set a lock bit in the control register to indicate a pending-lock state to denote that a cache line matching the address is to be locked when it is loaded. In certain embodiments, the loading of cache line may be the pre-loading described herein or loading of the cache line during normal instruction fetch cache line misses, wherein the instructions within the cache line would actually have been executed once the line is fetched.

The cache system pre-loads the cache line in step 203. After setting the pending lock state on a section of memory and executing a data memory load on one or more bytes or words from within the targeted memory line, the cache system may be forced to load the cache line and promote the pending lock state to a locked state in step 204. This can be regarded as pre-loading of the cache line to which this disclosure pertains. The section of memory may be that within the main system memory, or as any section of memory within any memory component wherein data may reside.

In certain embodiments, the locked state of the cache line, associated with instructions or data of the algorithm, will remove the specific cache line memory area from the pool of available local cache lines, thus preventing eviction due to subsequent cache line fetches during cache miss or pre-loads as detailed herein. When the particular cache line is no longer required to be locked, it may be returned to the pool of useable cache lines by releasing the locked state. This may be done by again writing the address of the byte or word associated with the particular cache line, which is to be released, into an appropriate register and setting an unlock bit in the control register.

In order to allow for both fetching a cache line into cache memory during normal cache line miss and forcing the cache line to be pre-loaded, as detailed herein, the cache system may use a decoder. In certain embodiments, the decoder may be preceded by the cache system. The decoder may allow for both instruction fetches during normal cache line miss cycles and pre-loads as detailed herein. It is to be understood that the actual working of a decoder would be readily apparent to one of ordinary skill in the art to which this disclosure belongs. In some embodiments disclosed herein, the terms “load” and “pre-load” may be used interchangeably.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine.

Further, although specific algorithms are described with reference to flowcharts depicted herein, persons of ordinary skill in the art will readily appreciate that many other methods of implementing the example machine-readable instructions may alternatively be used. For example, the order of execution of the blocks may be changed, and/or some of the blocks described may be changed, eliminated, or combined.

It should be noted that the algorithms illustrated and discussed herein as having various modules, which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method for caching using a cache system, the method comprising the steps of:
configuring the cache system for a pending lock state of a cache line;
pre-loading the cache line into cache memory; and
locking the cache line to prevent eviction of the cache line from the cache memory.

2. The method of claim 1, wherein pre-loading the cache line includes loading the cache line associated with instructions or data into the cache memory before an algorithm relying on the instructions or data needs them.

3. The method of claim 2, wherein pre-loading the cache line associated with instructions is done without execution of the instructions.

4. The method of claim 1, wherein the pending lock state is achieved by configuring the cache system to know that, when a cache line associated with an address is loaded into the cache memory, it should lock the cache line.

5. The method of claim 4, wherein the address is associated with instructions or data.

6. The method of claim 1, wherein locking the cache line is done by promoting the pending lock state to a locked state.

7. The method of claim 1, further comprising the step of unlocking the cache line to allow for eviction of the cache line from cache memory.

8. A computer-readable storage medium storing instructions that when executed by a computer causes the computer to perform a method for caching using a cache system, the method comprising the steps of:
configuring the cache system for a pending lock state of a cache line;
pre-loading the cache line into cache memory; and
locking the cache line to prevent eviction of the cache line from the cache memory.

9. A cache system comprising
a cache controller, a processor, and memory that are all operatively coupled to each other and configured to:
establish a pending lock state of a cache line;
pre-load the cache line into cache memory; and
lock the cache line to prevent eviction of the cache line from the cache memory.

10. The cache system of claim 9, wherein the cache system is configured to pre-load a plurality of cache lines simultaneously.
